(19) United States
(12) Patent Application Publication
(10) Pub. No.: US 2010/0214218 A1
(43) Pub. Date: Aug. 26, 2010

(54) VIRTUAL MOUSE

(75) Inventors: Matti Mikael Vaisanen, Helsinki (FI); Timo-Pekka Viljamaa, Helsinki (FI); Panu Korhonen, Helsinki (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/389,905

(22) Filed: Feb. 20, 2009

(51) Int. Cl. G09G 5/08; G06F 3/041; G06F 3/048

(52) U.S. Cl. 345/163; 345/173; 715/773

(57) ABSTRACT

An apparatus includes a controller, wherein the controller is configured to receive input for activating a virtual mouse and to activate a virtual mouse in response thereto by displaying a cursor adjacent a touch zone.

### FIELD

The present application relates to a user interface, an apparatus and a method for improved control, and in particular to a user interface, an apparatus and a method for improved control of a graphical user interface having a small display.

### BACKGROUND

Contemporary apparatuses with small displays with touch user interfaces have fewer user input controls than traditional Windows Icon Menu Pointer (WIMP) interfaces, but they still need to offer a similar set of responses to user actions, e.g. command and control possibilities. For example most web pages are designed for a large display, but are often viewed on a small display. The user of an apparatus with a small display should be offered the same level of control as the user of an apparatus with a large display.

A traditional WIMP (windows icons menus pointer) device may offer a mouse pointer, a left and right mouse button, a scroll wheel, keyboard scroll keys, and keyboard modifiers for mouse-clicks (e.g. control-left-mouse). A touch device relies entirely on touch on the screen with one or two fingers to send commands to the system, even where the underlying touch system is similar to the WIMP system and requires similar control information.

For most portable apparatus there is simply not space enough to offer all these control options.

An apparatus that allows easy and precise control of objects displayed on a small display would thus be useful in modern day society.

### SUMMARY

On this background, it would be advantageous to provide a user interface, an apparatus and a method that overcomes or at least reduces the drawbacks indicated above by providing an apparatus, a method, a computer readable medium and a user interface according to the claims.

Further features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application may be used according to an example embodiment,

FIG. 2 is a view of an apparatus according to an example embodiment,

FIG. 3 is a block diagram illustrating the general architecture of an apparatus of FIG. 2 in accordance with the present application,

FIGS. 4a, b, c, d and e are views of an apparatus according to an example embodiment,

FIGS. 5a and b are views of an apparatus according to an example embodiment,

FIGS. 6a and b are views of an apparatus according to an example embodiment, and

FIG. 7 is a flow chart describing a method according to an example embodiment of the application.

### DETAILED DESCRIPTION

In the following detailed description, the user interface, the apparatus, the method and the software product according to the teachings for this application in the form of a cellular/mobile phone will be described by the embodiments. It should be noted that although only a mobile phone is described the teachings of this application can also be used in any electronic device such as in portable electronic devices such as laptops, PDAs, mobile communication terminals, electronic books and notepads and other electronic devices offering access to information.

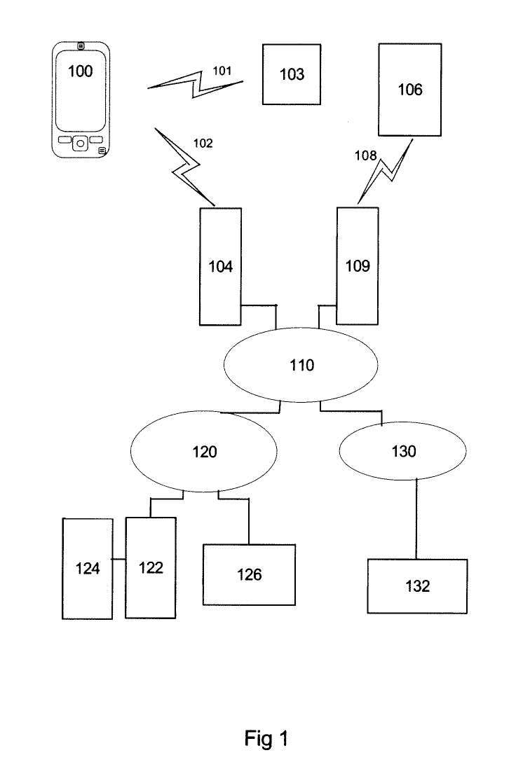

FIG. 1 illustrates an example of a cellular telecommunications system in which the teachings of the present application may be applied. In the telecommunication system of FIG. 1, various telecommunications services such as cellular voice calls, www or Wireless Application Protocol (WAP) browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through Radio Frequency (RF) links 102, 108 via base stations 104, 109. The mobile telecommunications network 110 may be in compliance with any commercially available mobile telecommunications standard, such as Group Spéciale Mobile (GSM), Universal Mobile Telecommunications System (UMTS), Digital Advanced Mobile Phone system (D-AMPS), The code division multiple access standards (CDMA and CDMA2000), Freedom Of Mobile Access (FOMA), and Time Division-Synchronous Code Division Multiple Access (TD-SCDMA).

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 as is commonly known by a skilled person. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, a Radio Standard link for example an RS-232 serial link, etc. The local devices 103 can for example be various sensors that can communicate measurement values to the mobile terminal 100 over the local link 101.

A computer such as a palmtop can also be connected to the network both via a radio link such as a WiFi link, which is the popular term for a radio frequency connection using the WLAN (Wireless Local Area Network) standard IEEE 802.11.

It should be noted that the teachings of this application are also capable of being utilized in an internet network of which the telecommunications network described above may be a part of.

As is commonly known the internet is a global system of interconnected computer networks that interchange data by packet switching using the standardized Internet Protocol Suite (TCP/IP). It is a “network of networks” that consists of millions of private and public, academic, business, and government networks of local to global scope that are linked by copper wires, fiber-optic cables, wireless connections, and other technologies.

The Internet carries various information resources and services, such as electronic mail, online chat, online gaming, file transfer and file sharing, and the inter-linked hypertext documents and other resources of the World Wide Web (WWW).

It should be noted that even though the teachings herein are described solely to wireless networks it is in no respect to be limited to wireless networks as such, but it to be understood to be usable in the Internet or similar networks. The teachings herein find use in any device having a touch input user interface where other input means, such as keyboards and joysticks, are limited. Examples of such devices are mobile phones, Personal digital Assistants (PDAs), game consoles, media players, personal organizers, electronic dictionaries and digital image viewers.

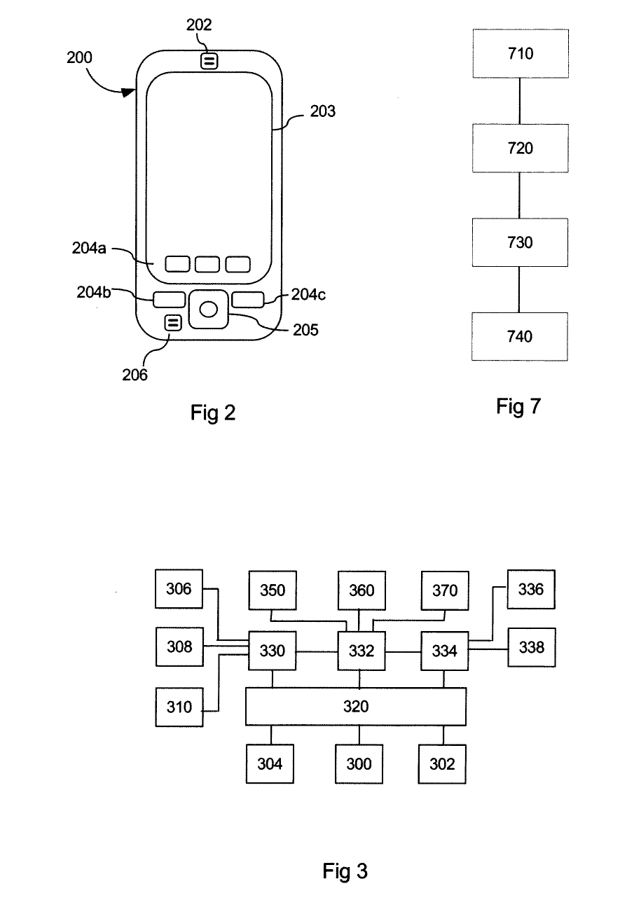

An embodiment 200 of the mobile terminal 100 is illustrated in more detail in FIG. 2. The mobile terminal 200 comprise a main or first display 203 which is a touch display, a microphone 206, a loudspeaker 202 and a key pad 204 comprising both virtual keys 204a and softkeys or control keys 204b and 204c. The apparatus also comprises a navigation input key such as a five-way key 205.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as Random Access Memory (RAM), Read Only Memory (ROM), Electrically Erasable Programmable Read-Only Memory (EEPROM), flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a message text editor 350, a notepad application 360, as well as various other applications 370, such as applications for voice calling, video calling, sending and receiving messages such as Short Message Service (SMS), Multimedia Message Service (MMS) or email, web browsing, an instant messaging application, a phone book application, a calendar application, a control panel application, a camera application, one or more video games, etc. It should be noted that two or more of the applications listed above may be executed as the same application.

The MMI 334 also includes one or more hardware controllers, which together with the MMI drivers cooperate with the touch display 336/203, and the keypad 338/204 as well as various other Input/Output devices such as microphone, speaker, vibrator, ringtone generator, LED indicator, etc.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, Analog to Digital and Digital to Analog (AD/DA) converters, etc.

The mobile terminal also has a Subscriber Identity Module (SIM) card 304 and an associated reader. As is commonly known, the SIM card 304 comprises a processor as well as local work and data memory.

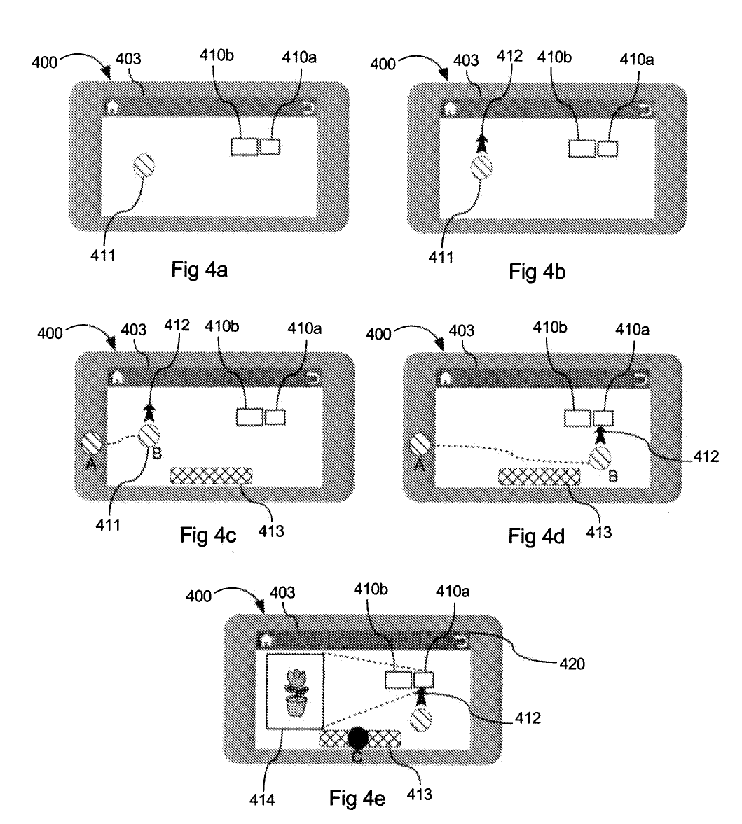

FIG. 4 show a view of an apparatus 400. It should be noted that such an apparatus is not limited to a mobile phone. In particular such an apparatus is capable of presenting controllable objects on a touch display.

Examples of such apparatuses are media players, mobile phones, personal digital assistants, digital cameras, navigation devices such as GPS (Global Positioning System) devices, game consoles end electronic dictionaries.

The apparatus 400 comprises a touch display 403 on which two objects 410a and 410b are displayed. Also indicated in FIG. 4a is the touching area 411 of a stylus (not shown). As can be seen in the figure the relative sizes of the objects 410 compared to the touching area 411 is that the objects are comparably small.

To provide improved control to a user a controller (not shown) is configured to display a cursor which can be controlled by touch input on the touch display 403. A user is thus able to use the cursor 412 as a virtual mouse.

This enables a user to accurately point at and control objects that are comparably small compared to the touching point of a finger or a stylus.

FIG. 4b shows a view of an apparatus where a cursor 412 is displayed slightly offset from the touching zone 411. In an example embodiment the cursor 412 is displayed adjacent the touching zone 411. In an example embodiment the cursor 411 is displayed adjacent the touch zone at a distance of 1, 2, 3, 4, 5, 6, 7, 8, 9 or 10 pixels from the touch zone. Other distances are also possible, for example in the range 10 to 15, 15 to 20 and 20 to 25 pixels. The number of pixels in the distance depends on design and usability issues such as display size, pixel size, stylus size. For example if the controller detects that a broad stylus is used, the controller displays the cursor at a greater distance from the touch zone than it would for a thin stylus. In one example embodiment the controller is configured to perform this dynamically. In the following the combination of the touch zone 411, the cursor 412 and the selection zone will be referred to as a virtual mouse 412.

As is readily understood the selection point of the cursor may be around its tip. By moving the selection zone from the touching zone the user is able to see better where he is pointing and also point with higher precision as the tip of the cursor is in most cases smaller than the tip of the stylus.

As the virtual mouse 412 finds best use with small options it would be preferable if the apparatus could offer a user the option of controlling the apparatus with both a direct touch and by the virtual mouse 412.

A controller is configured to activate the virtual mouse 412 upon detection of a slide-in gesture i.e. a touch input that originates outside the display 403. In one example embodiment a slide-in gesture can be determined as being a gesture that originates at or in the immediate vicinity of an edge of a display and immediately has a certain speed or a speed above a certain level. This allows a controller to differentiate between a gesture starting outside the display and continuing over it from a gesture deliberately starting close to an edge of the display and continuing inside the display, such as a gesture for selecting an object located close to the edge and dragging it inside the display area. The later gesture would have an initial speed close or equal to zero.

In one example embodiment the determination of the slide-in gesture depends on whether an object is covered by the path within a very short time interval.

In one example embodiment the slide-in gesture is assumed to have been performed if a user initiates it outside an active area or an application area of said display 403.

In this example embodiment a user may thus activate a virtual mouse 412 for a window by sliding in over the window.

In one example embodiment, which is shown in FIG. 4c, a controller has detected a slide in gesture from a touch in point A, which is outside the display 403 to a position B, which is inside the display 403, and a virtual mouse 412 has been activated by the controller.

The controller is further configured to receive touch input relating to a movement control of the virtual mouse 412 and move the virtual mouse 412 accordingly.

In order to provide a user with an increased control one or more virtual mouse buttons 413 are displayed as the virtual mouse 412 is activated. In one example embodiment the virtual mouse button is associated with one or more commands or functions. The controller is further configured to receive touch input relating to said virtual mouse button 413 and execute a command or function accordingly.

It should be noted that the virtual mouse button 413 may be arranged differently in different embodiments and the placement shown in FIG. 4 is merely to be regarded as an example. In one example embodiment having two touch displays the virtual mouse button is displayed in one display and the virtual mouse 412 is displayed in the other display. Furthermore it should be noted that the size, shape and location of the virtual mouse button 413 in FIG. 4 are only for illustrative and exemplary purposes and they may be of any shape, size or placement as a skilled person would realize.

In one example embodiment the controller is configured to determine whether the received touch input relating to the virtual mouse button 413 is a single-point or multi-point touch input. The controller is configured to execute different commands or functions accordingly. For example the function OPEN is in one example embodiment associated with a single touch on the virtual mouse button 413 and a function of displaying an options menu is associated with a double touch on the virtual mouse button 413.

This provides a user with the option of controlling the virtual cursor 412 with one finger and the selected action with one or more other fingers.

In one example embodiment the controller is configured to detect one or more gestures relating to the virtual mouse button 413. Each gesture is associated with an action (command or function) and the controller is configured to execute the associated command or function in response to detecting the gesture. In one example the function OPEN is associated with a touch or tap on the virtual mouse button 413 and the function of displaying an options list is associated with a sliding gesture on the virtual mouse button 413.

In one example embodiment the associated function is further determined by the object 410. For example, the function associated with an object representing a music file can be to play the music file and the function associated with an object representing an image file can be to display the image.

It should be noted that when a virtual mouse 412 is active the controller is configured to display one or several virtual mouse buttons 413 inside an application view and the user can use these virtual mouse buttons 413 with another/second finger for triggering mouse button down and up events for an object identified with a virtual mouse 412 resulting in the same outcome as would be produced with a physical mouse interaction when using standard computers. If the user would interact with a document instead of virtual mouse buttons 413 with his/her second finger the controller would execute a default function/feature provided for by the application. In an exemplary embodiment of an Internet or Hypermedia application, the controller would display at least a left and a right virtual mouse button. It should also be noted that a virtual mouse 412 can comprise as many virtual buttons 413 as needed for different purposes whatever relevant in the current context.

In one example embodiment the controller is configured to execute a command or function when the controller detects that the touch input is released.

In one example embodiment the controller is configured to deactivate the virtual mouse without executing a command or function when the controller detects that the touch input is released.

FIG. 4d shows an apparatus 400 where a user has activated a virtual mouse 412 and positioned it so that it identifies one object 410a.

As a user taps on the virtual mouse button 413 an associated action is executed by the controller. See FIG. 4e where the object 410a represents an image file and the associated action is to display the image. As the user has tapped on the virtual mouse button 413 in position C (the tap being indicated by the black circle which is shown for illustrative purposes and need not be displayed in an implementation) the controller has launched an image viewing application 414 showing the image file being represented by the object 410a. In FIG. 4e dashed lines are shown to indicate that the application window 414 has been opened for object 410a. It should be noted that these dashed lines do not need to be displayed on an apparatus according to the teachings herein.

In one example embodiment the controller is configured to receive touch input and to detect a pressure level of the received input. The controller is further configured to associate various commands or actions to specified pressure levels. This provides for a feature of moving the virtual mouse 412 using low pressure touch input and selecting commands by using touch input with higher pressure. In one example embodiment a user could thus move the virtual mouse by sliding his finger and then “clicking” on an item by pushing harder on the touch display. A move operation in such an embodiment would be achieved by moving the virtual mouse to an object and pressing down on the object. Then move the object to another position where the pressure would be lowered gain, i.e. the user would not push so hard.

In one example embodiment the controller is configured to receive multiple touch input from the touch display. The controller is further configured to receive first touch input and to associate this first input with the virtual mouse and to interpret the first input as a continuous stream of movement and control info for the virtual mouse. The controller is also configured to receive at least a second input and associate the second input with commands that are not related to the virtual mouse 412. In one example embodiment the second input is related to a panning action of content that is displayed on the display. In such an embodiment a user can activate virtual mouse by sliding in a finger on the display and then by placing a second finger on the display and moving the second finger the user is able to pan the displayed content. This would alleviate the requirement for having scrollbars. In one example embodiment the controller is configured to determine all input to be related to a second action that is not related to the control of the virtual mouse as a multiple touch input is detected. In such an embodiment the user is able to start a virtual mouse by sliding in one finger and then by touching the screen with a second finger all actions taken are determined to be related to the second action and not control of the virtual mouse while the multi-touch is detected. To return to controlling the virtual mouse the user simply releases the second touch e.g. releases the second finger.

In one example embodiment the second input is associated with a zoom function. In such an embodiment the user is able to zoom in/out with a pinch or release gesture. For example when a user has moved the virtual mouse cursor with one finger to an application view, the user is able to zoom in/out the view with a two-finger pinch gesture by bringing a second finger to the screen. After zoom in/out the user releases the second finger and continues the normal cursor movement with the first finger.

In one example embodiment the virtual mouse is de-activated as the touch input is released. In one example embodiment the controller is configured to execute an action if the mouse is de-activated while identifying i.e. pointing at an object. This enables a user to be able to activate a virtual mouse 412, slide it out to an object 410 and execute on action on the object by one single and simple sliding gesture.

In one example embodiment the controller is configured to deactivate the virtual mouse without executing a command or function when the controller detects that the touch input is released.

In one example embodiment the virtual mouse is de-activated if it is brought outside the window or application area for which it was activated.

It should be noted that in FIGS. 4a to 4e a graphical user interface of an application being executed on an apparatus 420 is displayed. In this example it is a toolbar 420. In one example embodiment the controller is configured to deactivate the toolbar 420 and no longer display the toolbar 420 as a virtual mouse is activated. This allows more display space to be used for displaying the virtual mouse button(s) 413.

It should also be noted that the virtual mouse of this application will also find use for enabling a user to handle and/or control objects which have functions associated with it which functions are dependant on the interaction. This makes a touch based user interface more compatible with other user interfaces having additional input means such as a physical mouse and content designed for one system can easily be controlled in a different system. For example, an object is displayed on a display. The object is associated with a number of functions one being that as a cursor hovers over the object (a mouse over event) a pop-up menu is displayed. The virtual mouse of this application enables a user interface not having a navigational input device to implement such functions and to allow designers and users to differentiate between mouse down, mouse up and mouse over events in a manner that is intuitive both to implement and for a user to use.

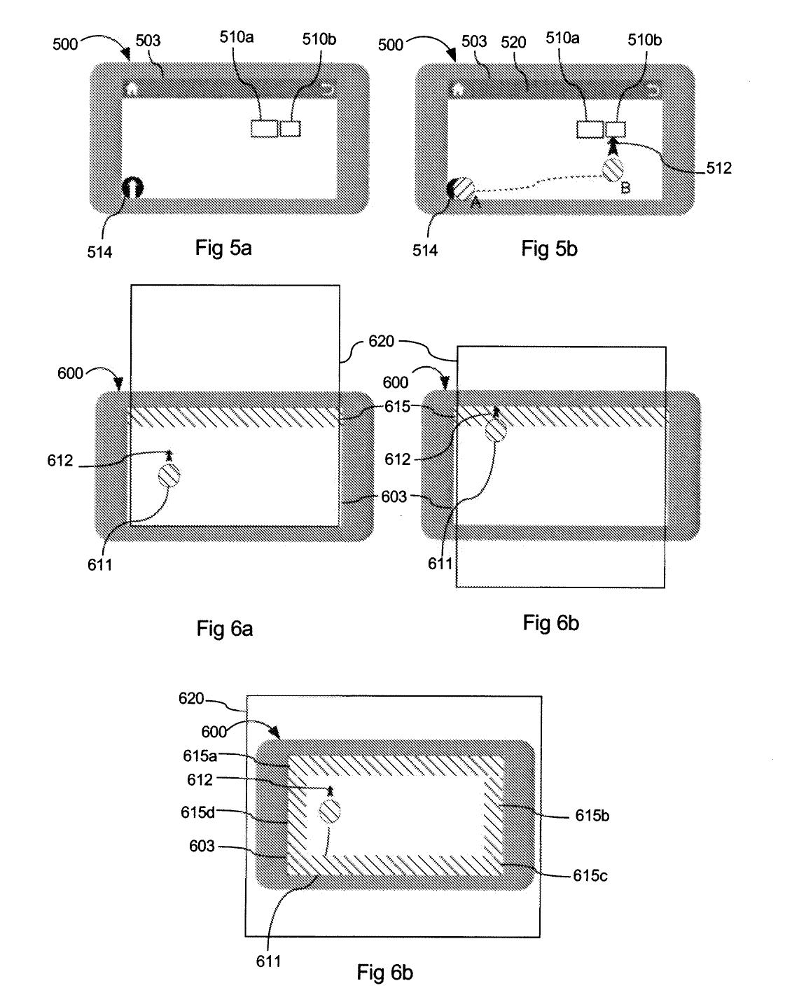

FIG. 5 show a view of an apparatus 500 according to the teachings herein. In particular such an apparatus is capable of presenting controllable objects on a touch display.

The apparatus 500 comprise a touch display 503 on which two objects 510a and 510b are displayed. Also displayed is an icon 514 for activating a virtual mouse.

In this embodiment a controller is configured to detect a gesture originating in the virtual mouse icon 514 and in response thereto activate a virtual mouse 512. The controller is configured to receive control input for the virtual mouse as has been described with reference to FIG. 4.

This enables a user with an intuitive starting point for activating the virtual mouse 512.

In one example embodiment a controller is configured to activate a virtual mouse 512 upon detection of any touch input on the icon 514. And in one example embodiment if a tap is detected on the icon 514. In one example embodiment the virtual mouse 512 is displayed adjacent the icon 514 when activated. In one example embodiment the virtual mouse 512 is displayed adjacent in the middle of the display 503 when activated.

In one example embodiment the controller is configured to de-activate the virtual mouse 512 if it is brought back to the icon 514, that is by bringing it back to point A.

In one example embodiment the controller is configured to de-activate the virtual mouse 512 upon detection of further input on the icon 514.

In one example embodiment the controller is configured to de-activate the virtual mouse 512 in one of the ways described with reference to FIG. 4.

In FIG. 5b a user has started a touch gesture in point A overlapping with icon 515 and a controller has been caused to activate a virtual mouse 512 which the user has slid across the screen to point B. As in FIGS. 4c and 4d sliding paths are indicated by dashed lines. These dashed lines are only shown for illustrative purposes and need not be implemented.

It should be noted that the placement of the icon 514 is only for illustrative purposes and the icon 514 may be placed in other positions on the display 503 in different embodiments. In one example embodiment it is part of a toolbar 520. In one example embodiment the icon's 514 placement is dependant on an application being executed. In one example embodiment the icon is displayed according to a context of an application. For example the icon 514 is only displayed if any actions can be undertaken with a virtual mouse 512.

FIG. 6 shows a view of an apparatus 600 according to the teachings herein. In particular such an apparatus is capable of presenting controllable objects on a touch display.

The apparatus 600 comprises a touch display 603 on which content 620 is displayed. In this example the content 620 has a graphical extent exceeding the resolution of the touch display 603 which in this example results in that the full content 620 can not be displayed at once. This is indicated in the figure by the content 620 extending outside the touch display 603. This is only for illustrative purposes as a skilled reader would realize and in an implementation the portion of the content 620 extending outside the touch display 603 would not be visible.

In FIG. 6a a user has already activated a virtual mouse 612 which is displayed at a touch point 611.

A controller is configured to arrange at least one scroll command portion 615 along at least one side of the touch display 603.

In this example only one scroll command portion 615 is shown along the top edge of the display 603.

In one example embodiment the scroll command portions 615 are not visible.

In one example embodiment the scroll command portions 615 are marked. In one example embodiment they are marked by being shaded.

In one example embodiment a scroll command portion 615 is marked as a controller determines that a virtual mouse is located in a scroll command portion 615.

A controller is configured to determine whether a virtual mouse 612 is located within a scroll command portion 615 or not. If it is determined that a virtual mouse 612 is located within a scroll command portion 615 the controller is configured to scroll the content 620 in response thereto and in a direction corresponding to the location of the scroll command portion 615.

In FIG. 6b the virtual mouse 612 is located within the scroll command portion 615 and the content 620 is displayed showing a different portion. The new portion of the content 620 that is displayed is the portion that was outside the top portion of the touch display 603. Thus a user has been able to indicate to the controller that he wishes to scroll to view the portion that is located outside an edge of the display by placing the virtual mouse 612 in close proximity to that edge in an arranged scroll command portion.

In one example embodiment the controller is configured to determine that the virtual mouse 612 is located within a scroll command portion 615 if the virtual mouse 612 at least partially overlaps the scroll command potion 615.

FIG. 6c shows an apparatus as in FIG. 6b where four scroll command portions 615a, b, c and d are located adjacent the top, left, bottom and right side of the display 603.

A controller is configured to determine whether a virtual mouse 612 is located in any of the scroll command portions scroll command portions 615a, b, c and d and if so to scroll the content accordingly.

In this example the controller is configured to scroll the content 620 downwards if the virtual mouse 612 is located within the upper scroll command portion 615a.

In this example the controller is configured to scroll the content 620 leftwards if the virtual mouse 612 is located within the right scroll command portion 615b.

In this example the controller is configured to scroll the content 620 upwards if the virtual mouse 612 is located within the lower scroll command portion 615c.

In this example the controller is configured to scroll the content 620 rightwards if the virtual mouse 612 is located within the left scroll command portion 615d.

The directions used are those which are perceived as an apparatus is viewed from the front as displayed in FIG. 6.

In one example embodiment the width of the scroll command portion 615 is set in accordance with the width of the stylus used.

In one example embodiment the width of the scroll command portion 615 is fixed to a preset value independent of the width of the stylus used.

In one example embodiment the width of the scroll command portion 615 is set in proportion to the available display size and in one example embodiment to the width of an application window being displayed (not shown).

FIG. 7 shows a flow chart of a method according to the teachings herein. In an initial step 710 a controller detects a gesture for activating a virtual mouse and the controller activates and displays the virtual mouse in step 720. The virtual mouse is then controlled through further touch input received by the controller in step 730. In step 740 the controller receives a de-activation command and de-activates the virtual mouse accordingly.

In one example embodiment an apparatus has a foldable display or alternatively two displays arranged on opposite sides of the apparatus. Such an apparatus will have one first touch display area on a front face of the apparatus and one second touch display area on a back face of the apparatus. In such an embodiment a controller may be configured to receive touch input on the second touch display area and in response thereto display a virtual mouse on the first touch area. The controller may further be configured to receive control input for the virtual mouse through the second touch area to control the virtual mouse on the first touch area. In one example embodiment the first touch are is not touch sensitive but merely a display.

Such embodiments enable a user to control a virtual mouse on a front display (portion) by making touch input on a back side of an apparatus.

The various aspects of what is described above can be used alone or in various combinations. The teaching of this application may be implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in Personal digital Assistants (PDAs), game consoles, media players, personal organizers, electronic dictionaries, computers or any other device designed for displaying content on a small touch display.

The teaching of the present application has numerous advantages. Different embodiments or implementations may yield one or more of the following advantages. It should be noted that this is not an exhaustive list and there may be other advantages which are not described herein. For example, one advantage of the teaching of this application is that a user is offered improved control of small objects being displayed on a touch display.

Although the teaching of the present application has been described in detail for purpose of illustration, it is understood that such detail is solely for that purpose, and variations can be made therein by those skilled in the art without departing from the scope of the teaching of this application.

For example, the teaching of the present application has been described in terms of a mobile phone, it should be appreciated that the teachings of the present application may also be applied to other types of electronic devices, such as media players, palmtop, game consoles, digital cameras, electronic dictionaries and so on. It should also be noted that there are many alternative ways of implementing the methods and apparatuses of the teachings of the present application.

Features described in the preceding description may be used in combinations other than the combinations explicitly described.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

The term “comprising” as used in the claims does not exclude other elements or steps. The term “a” or “an” as used in the claims does not exclude a plurality. A unit or other means may fulfill the functions of several units or means recited in the claims.

1. An apparatus comprising a controller, wherein said controller is configured to
receive input for activating a virtual mouse and to
activate a virtual mouse in response thereto by displaying a cursor adjacent a touch zone.

2. An apparatus according to claim 1, wherein said controller is further configured to
receive movement control input and to display the virtual mouse at altering positions according to the movement control input.

3. An apparatus according to claim 1, wherein said controller is further configured to receive a touch input representing a slide-in gesture and to determine that said received touch input is an input to activate the virtual mouse.

4. An apparatus according to claim 1, wherein said controller is further configured to receive a de-activation command and to de-activate the virtual mouse accordingly.

5. An apparatus according to claim 4, wherein said controller is further configured to receive a release of a touch input and to determine that said received touch input represents a de-activation command.

6. An apparatus according to claim 1, wherein said controller is further configured to display a virtual mouse button.

7. An apparatus according to claim 6, wherein said virtual mouse button is associated with a command and said controller being further arranged to receive touch input relating to said virtual mouse button and in response thereto execute the associated command.

8. An apparatus according to claim 1, wherein said input is touch input and wherein said controller is further configured to receive a second touch input and to execute a function accordingly.

9. An apparatus according to claim 1 wherein said controller is further configured to display content on a display and to determine whether a virtual mouse is located in a specific area and in response thereto scroll said content.

10. An apparatus comprising:
input means for receiving input for activating a virtual mouse,
control means for activating a virtual mouse in response thereto and display means for displaying a cursor adjacent a touch zone.

11. A computer readable medium comprising at least computer program code for controlling an apparatus, said computer readable medium comprising:
software code for receiving input for activating a virtual mouse,
software code for activating a virtual mouse in response thereto and software code for displaying a cursor adjacent a touch zone.

12. A method comprising:
receiving input for activating a virtual mouse and
activating a virtual mouse in response thereto by displaying a cursor adjacent a touch zone.

13. A method according to claim 12, further comprising receiving movement control input and displaying the virtual mouse at altering positions according to the movement control input.

14. A method according to claim 12, further comprising receiving a touch input representing a slide-in gesture as the input to activate the virtual mouse.

15. A method according to claim 12, further comprising receiving a de-activation command and to de-activate the virtual mouse accordingly.

16. A method according to claim 15, further comprising receiving a release of a touch input and determining that said received touch input represents a de-activation command.

17. A method according to claim 12, further comprising displaying a virtual mouse button.

18. A method according to claim 12, further comprising:
associating a virtual mouse button with a command;
receiving touch input relating to said virtual mouse button; and
in response thereto executing the associated command.

19. A method according to claim 12, wherein said input is touch input and wherein the method further comprises receiving a second touch input and executing a function accordingly.

20. A method according to claim 12, further comprising displaying content on a display and determining whether a virtual mouse is located in a specific area and in response thereto scrolling said content.
